(19) United States
(12) Patent Application Publication
(10) Pub. No.: US 2014/0111732 A1
(43) Pub. Date: Apr. 24, 2014

(54) LIQUID CRYSTAL DISPLAY DEVICE

(71) Applicants: Gang Yu, Shenzhen City (CN); Yubo Gu, Shenzhen City (CN); Pei Jia, Shenzhen City (CN); Liuyang Yang, Shenzhen City (CN)

(72) Inventors: Gang Yu, Shenzhen City (CN); Yubo Gu, Shenzhen City (CN); Pei Jia, Shenzhen City (CN); Liuyang Yang, Shenzhen City (CN)

(73) Assignee: Shenzhen China Star Optoelectronics Technology Co. Ltd., Shenzhen, Guangdong (CN)

(21) Appl. No.: 13/805,659

(22) PCT Filed: Nov. 8, 2012
(86) PCT No.: PCT/CN12/84260

§ 371 Date: Dec. 19, 2012

(30) Foreign Application Priority Data
Oct. 23, 2012 (CN) 201210407564.8

(51) Int. Cl. G02F 1/1335

(52) U.S. Cl. CPC G02F 1/133615
USPC 349/58; 349/62

(57) ABSTRACT

The present invention provides a liquid crystal display module, which includes a backlight module, a liquid crystal display panel arranged above the backlight module, a scattered reflection layer arranged on the liquid crystal display panel, and a front frame mounted on the scattered reflection layer. The scattered reflection layer is transparent, whereby light generated by the backlight module, after passing through the liquid crystal display panel, is subjected to refraction and scattered reflection in the scattered reflection layer. The liquid crystal display module uses a curved scattered reflection layer arranged on a light emergence surface of a liquid crystal panel to subject the light passing through the liquid crystal panel to refraction and scattered reflection so as to generate light in multiple angle thereby expanding the range of viewing angle, improving viewing angle characteristics, and enhancing the quality of the liquid crystal display module.

### BACKGROUND OF THE INVENTION

1. Field of the Invention

The present invention relates to the field of liquid crystal display, and in particular to a liquid crystal display device that improves viewing angle characteristics.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The operation principle of the liquid crystal panel is that liquid crystal molecules are interposed between two parallel glass substrates and a plurality of vertical and horizontal fine electrical wires are arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module comprises a light source, such as a cold cathode fluorescent lamp (CCFL) or a light-emitting diode (LED), which is arranged at the back side of the liquid crystal panel to form a planar light source that directly provides lighting to the liquid crystal panel. The side-edge backlight module comprises a backlight source of LED light bar arranged at an edge of a backplane to be located rearward of one side of the liquid crystal panel. The LED light bar emits light that enters a light guide plate (LGP) through a light incident face of the light guide plate and is projected out through a light emergence face of the light guide plate, after being reflected and diffused, to thereby transmit through an optic film assembly and form a planar light source for the liquid crystal panel. The liquid crystal panel material used in a regular TN type liquid crystal display panel is generally P type liquid crystal material with positive dielectric characteristic. With no electricity applied thereto, the liquid crystal molecules are parallel to two opposite substrates of the liquid crystal display panel and adjacent liquid crystal molecules are lined up independently. Although the TN type liquid crystal material has been progressively developed, there are still issues to be overcome, such as the defect of contrast in viewing a high contrast image. Further, the liquid crystal material that is used in a regular VA type liquid crystal display panel is N type liquid crystal material with negative dielectric characteristic. When no electricity is applied, the liquid crystal molecules are perpendicular to two opposite substrates of the liquid crystal display panel. And, polarizers are respectively mounted to the surfaces of the two substrates. Such a liquid crystal display device can easily acquire high level contrast that is not available for TN type liquid crystal display panel. When electricity is applied to induce an electric field, the liquid crystal molecules are generally located on liquid crystal planes that are parallel to the substrates. Further, a polarized component of light emitting from a backlight that transmits through the polarizer will pass through rotated liquid crystal molecules.

As shown in FIG. 1, the liquid crystal molecules of a VA type liquid crystal display device show different contrasts at different directions of observation, such as different contrasts a, b, c that are obtained by observing at three different directions A, B, C, and thus deterioration of the viewing angle characteristics may result. In the trend of development, with the size of substrate increasingly enlarged and response time increasingly shortened, improving viewing angle characteristics is a need for the VA type liquid crystal display substrate.

### SUMMARY OF THE INVENTION

An object of the present invention is to provide a liquid crystal display module, which comprises a liquid crystal panel having a light emergence surface on which a scattered reflection layer is coated so as to expand the range of viewing angle, improve viewing angle characteristics, and enhance the quality of liquid crystal display module, but with the contrast being maintained.

To achieve the object, the present invention provides a liquid crystal display module, which comprises a backlight module, a liquid crystal display panel arranged above the backlight module, a scattered reflection layer arranged on the liquid crystal display panel, and a front frame mounted on the scattered reflection layer. The scattered reflection layer is transparent, whereby light generated by the backlight module, after passing through the liquid crystal display panel, is subjected to refraction and scattered reflection in the scattered reflection layer.

The backlight module comprises a backplane, a reflector plate arranged inside the backplane, a light guide plate arranged on the reflector plate, an optic film arranged on the light guide plate, a backlight source arranged inside the backplane, and an intermediate frame mounted on the backplane. The liquid crystal display panel is mounted on the intermediate frame.

The backplane comprises a bottom board and side boards perpendicularly connected to the bottom board. The side boards and the bottom board define a receiving space, whereby the reflector plate, the light guide plate, the optic film, and the backlight source are received in the receiving space.

The reflector plate is positioned on the bottom board of the backplane. The backlight source is fixed to the side boards of the backplane.

The backlight source comprises a linear LED light source, which is fixed to the side boards of the backplane by means of bonding with thermally conductive adhesive tape or screwing.

The scattered reflection layer comprises a concave or convex refraction layer having a curvature.

The scattered reflection layer comprises a scattered reflection film.

The scattered reflection layer comprises a scattered reflection coating.

The scattered reflection layer comprises a curved board.

The present invention also provides a liquid crystal display module, which comprises a backlight module, a liquid crystal display panel arranged above the backlight module, a scattered reflection layer arranged on the liquid crystal display panel, and a front frame mounted on the scattered reflection layer, the scattered reflection layer being transparent, whereby light generated by the backlight module, after passing through the liquid crystal display panel, is subjected to refraction and scattered reflection in the scattered reflection layer;

wherein the backlight module comprises a backplane, a reflector plate arranged inside the backplane, a light guide plate arranged on the reflector plate, an optic film arranged on the light guide plate, a backlight source arranged inside the backplane, and an intermediate frame mounted on the backplane, the liquid crystal display panel being mounted on the intermediate frame;

wherein the backplane comprises a bottom board and side boards perpendicularly connected to the bottom board, the side boards and the bottom board defining a receiving space, whereby the reflector plate, the light guide plate, the optic film, and the backlight source are received in the receiving space;

wherein the reflector plate is positioned on the bottom board of the backplane, the backlight source being fixed to the side boards of the backplane;

wherein the backlight source comprises a linear LED light source, which is fixed to the side boards of the backplane by means of bonding with thermally conductive adhesive tape or screwing;

wherein the scattered reflection layer comprises a concave or convex refraction layer having a curvature; and

wherein the scattered reflection layer comprises a scattered reflection film.

The efficacy of the present invention is that the present invention provides a liquid crystal display module, which comprises a curved scattered reflection layer arranged on a light emergence surface of a liquid crystal panel to subject the light passing through the liquid crystal panel to refraction and scattered reflection so as to generate light in multiple angle thereby expanding the range of viewing angle, improving viewing angle characteristics, enhancing the quality of the liquid crystal display module, and thus facilitating development of liquid crystal display module toward large size but with the contrast being maintained.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawing. In the drawing:

FIG. 1 is a schematic view illustrating different contrasts at different directions for a conventional VA type liquid crystal display device;

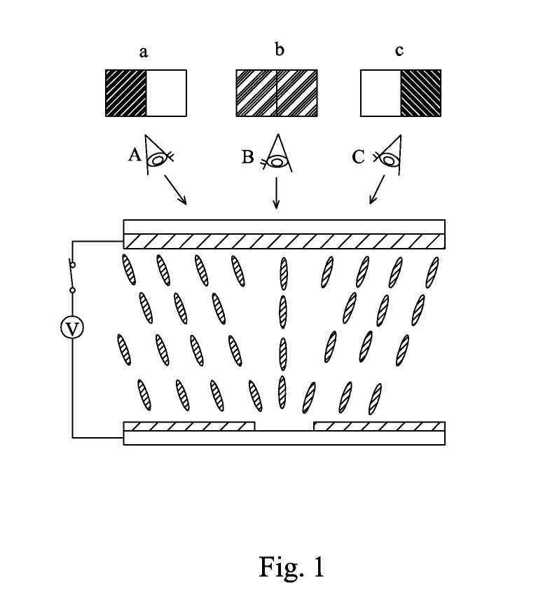

FIG. 2 is a schematic view showing the structure of a liquid crystal display module according to a first preferred embodiment of the present invention;

FIG. 3 is schematic view showing the principle of the liquid crystal display module of the present invention;

FIG. 4 is a schematic view showing the structure of a liquid crystal display module according to a second preferred embodiment of the present invention; and

FIG. 5 is a schematic view showing the structure of a liquid crystal display module according to a third preferred embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

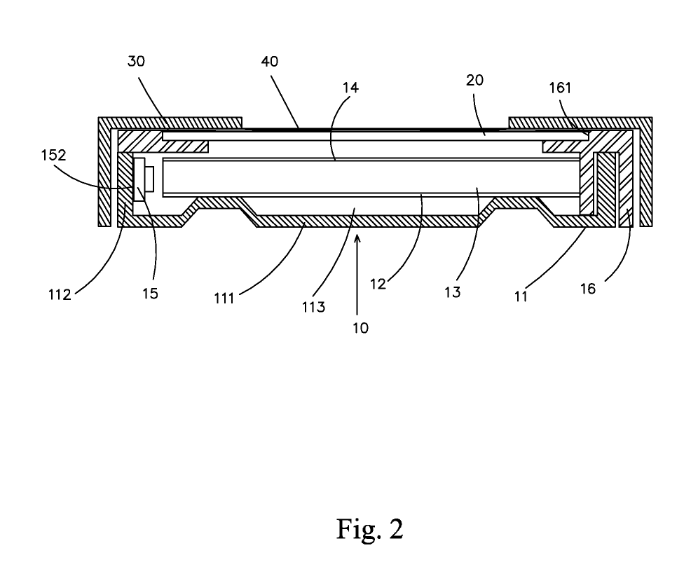

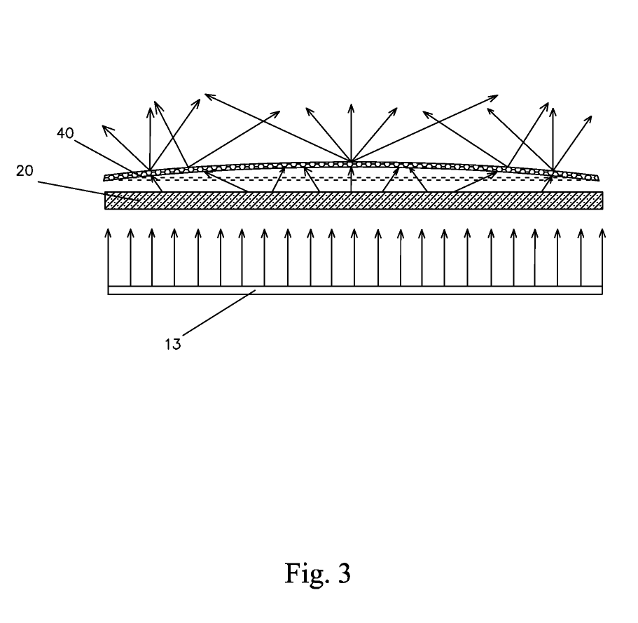

Referring to FIGS. 2 and 3, the present invention provides a liquid crystal display module, which comprises a backlight module 10, a liquid crystal display panel 20 arranged above the backlight module 10, a scattered reflection layer 40 arranged on the liquid crystal display panel 20, and a front frame 30 mounted on the scattered reflection layer 40. The scattered reflection layer 40 is transparent. Light generated by the backlight module 10, after passing through the liquid crystal display panel 20, is subjected to refraction and scattered reflection in the scattered reflection layer 40 so as to expand viewing angle of the liquid crystal display module and improve viewing angle characteristics.

The backlight module 10 further comprises a backplane 11, a reflector plate 12 arranged inside the backplane 11, a light guide plate 13 arranged on the reflector plate 12, an optic film 14 arranged on the light guide plate 13, a backlight source 15 arranged inside the backplane 11, and an intermediate frame 16 mounted on the backplane 11. The liquid crystal display panel 20 is mounted on the intermediate frame 16.

The backplane 11 comprises a bottom board 111 and side boards 112 perpendicularly connected to the bottom board 111. The side boards 112 and the bottom board 111 define a receiving space 113. The reflector plate 12, the light guide plate 13, the optic film 14, and the backlight source 15 are received in the receiving space 113. The reflector plate 12 is positioned on the bottom board 111 of the backplane 11.

The backlight source 15 comprises a linear LED light source, which is fixed to the side boards 112 of the backplane 11 by means of bonding with thermally conductive adhesive tape or screwing. The backlight source 15 emits light that directly enters or is reflected by the reflector plate 12 to enter the light guide plate 13 and subsequently enters the optic film 14 to provide a planar light source of homogeneous illumination to the liquid crystal display panel 20.

The scattered reflection layer 40 is a concave or convex refraction layer having a curvature. In the instant preferred embodiment, the scattered reflection layer 40 comprises a scattered reflection film. The scattered reflection film is made of a transparent material, such as transparent plastics and shows transparency. Light leaving the liquid crystal panel is subjected to refraction inside the scattered reflection film and is further subjected to scattered reflection at a light emergence surface of the scattered reflection film so as to generate light in multiple angles and thus expand viewing angle and improve viewing angle characteristics, thereby facilitating development of the liquid crystal display module toward large size.

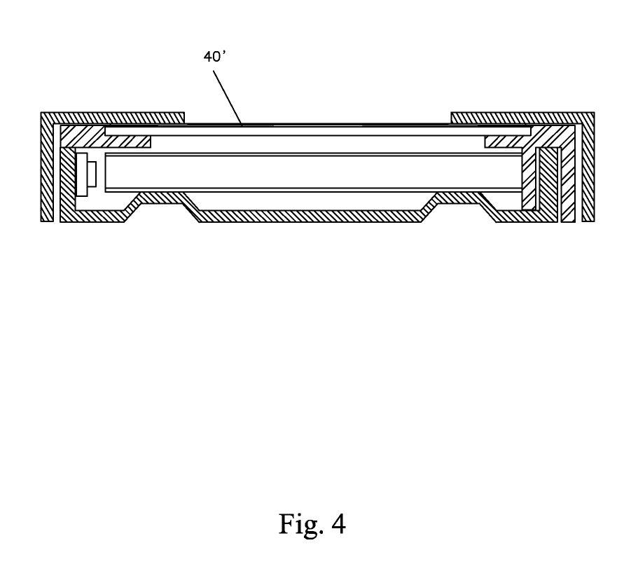

Referring to FIG. 4, as an alternative second preferred embodiment, the instant preferred embodiment is different from the previous first preferred embodiment in that the scattered reflection layer 40′ is a scattered reflection coating, which is transparent. The scattered reflection layer 40′ is made of a transparent coating material.

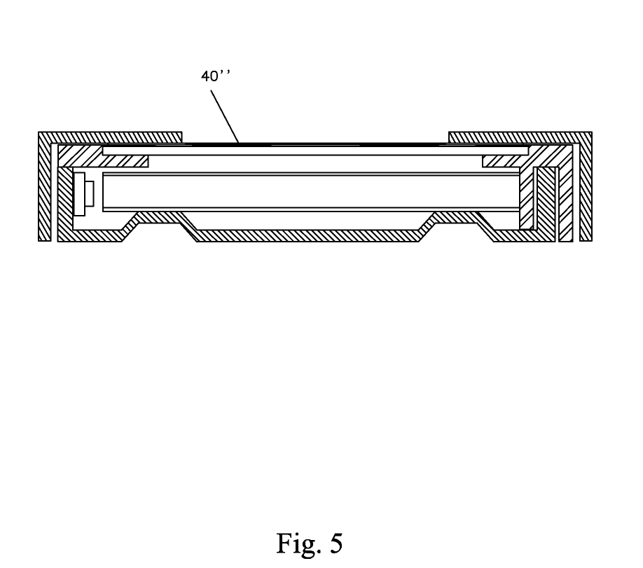

Referring to FIG. 5, as an alternative third preferred embodiment, the instant preferred embodiment is different from the previous first and second preferred embodiments in that the scattered reflection layer 40″ is a curved board that is transparent. The curved board based scattered reflection layer 40″ is made of acrylic board.

In summary, the present invention provides a liquid crystal display module, which comprises a curved scattered reflection layer arranged on a light emergence surface of a liquid crystal panel to subject the light passing through the liquid crystal panel to refraction and scattered reflection so as to generate light in multiple angle thereby expanding the range of viewing angle, improving viewing angle characteristics, enhancing the quality of the liquid crystal display module, and thus facilitating development of liquid crystal display module toward large size but with the contrast being maintained.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display module, comprising a backlight module, a liquid crystal display panel arranged above the backlight module, a scattered reflection layer arranged on the liquid crystal display panel, and a front frame mounted on the scattered reflection layer, the scattered reflection layer being transparent, whereby light generated by the backlight module, after passing through the liquid crystal display panel, is subjected to refraction and scattered reflection in the scattered reflection layer.

2. The liquid crystal display module as claimed in claim 1, wherein the backlight module comprises a backplane, a reflector plate arranged inside the backplane, a light guide plate arranged on the reflector plate, an optic film arranged on the light guide plate, a backlight source arranged inside the backplane, and an intermediate frame mounted on the backplane, the liquid crystal display panel being mounted on the intermediate frame.

3. The liquid crystal display module as claimed in claim 2, wherein the backplane comprises a bottom board and side boards perpendicularly connected to the bottom board, the side boards and the bottom board defining a receiving space, whereby the reflector plate, the light guide plate, the optic film, and the backlight source are received in the receiving space.

4. The liquid crystal display module as claimed in claim 3, wherein the reflector plate is positioned on the bottom board of the backplane, the backlight source being fixed to the side boards of the backplane.

5. The liquid crystal display module as claimed in claim 4, wherein the backlight source comprises a linear LED light source, which is fixed to the side boards of the backplane by means of bonding with thermally conductive adhesive tape or screwing.

6. The liquid crystal display module as claimed in claim 1, wherein the scattered reflection layer comprises a concave or convex refraction layer having a curvature.

7. The liquid crystal display module as claimed in claim 6, wherein the scattered reflection layer comprises a scattered reflection film.

8. The liquid crystal display module as claimed in claim 6, wherein the scattered reflection layer comprises a scattered reflection coating.

9. The liquid crystal display module as claimed in claim 6, wherein the scattered reflection layer comprises a curved board.

10. A liquid crystal display module, comprising a backlight module, a liquid crystal display panel arranged above the backlight module, a scattered reflection layer arranged on the liquid crystal display panel, and a front frame mounted on the scattered reflection layer, the scattered reflection layer being transparent, whereby light generated by the backlight module, after passing through the liquid crystal display panel, is subjected to refraction and scattered reflection in the scattered reflection layer;
wherein the backlight module comprises a backplane, a reflector plate arranged inside the backplane, a light guide plate arranged on the reflector plate, an optic film arranged on the light guide plate, a backlight source arranged inside the backplane, and an intermediate frame mounted on the backplane, the liquid crystal display panel being mounted on the intermediate frame;
wherein the backplane comprises a bottom board and side boards perpendicularly connected to the bottom board, the side boards and the bottom board defining a receiving space, whereby the reflector plate, the light guide plate, the optic film, and the backlight source are received in the receiving space;
wherein the reflector plate is positioned on the bottom board of the backplane, the backlight source being fixed to the side boards of the backplane;
wherein the backlight source comprises a linear LED light source, which is fixed to the side boards of the backplane by means of bonding with thermally conductive adhesive tape or screwing;
wherein the scattered reflection layer comprises a concave or convex refraction layer having a curvature; and
wherein the scattered reflection layer comprises a scattered reflection film.
